(19) United States
(12) Patent Application Publication
(10) Pub. No.: US 2008/0086555 A1
(43) Pub. Date: Apr. 10, 2008

(54) System and Method for Search and Web Spam Filtering

(76) Inventor: DAVID ALEXANDER FEINLEIB, Palo Alto, CA (US)

Correspondence Address: DAVID ALEXANDER FEINLEIB, 124 PROMISE WAY, PALO ALTO, CA, 94303, US

(21) Appl. No.: 11/539,673

(22) Filed: Oct. 9, 2006

(51) Int. Cl. G06F 15/173

(52) U.S. Cl. 709/224

(57) ABSTRACT

The invention is a system and method for the detection and filtering of search and web spam. More specifically, the invention relates to a number of software modules, including client and server software, processes, and algorithms that perform these functions. By detecting and filtering out search and web spam, the invention provides a unique and novel way to view content that is relevant and meaningful to users of the world wide web.

### FIELD OF THE INVENTION

The field of invention relates generally to a system and method for detecting and filtering search and web spam. More specifically, the invention relates to software processes and methods that are used in the server software, client software, and algorithms to analyze Universal Resource Locators (URL)s and the content of web pages to determine if a URL or web page is spam and to indicate to the user that this is the case or remove the detected spam from view of the user. Additionally, the invention relates to algorithms for learning, based on user feedback, which URLs and web pages are indicative of spam content.

### BACKGROUND INFORMATION

It can be appreciated that in recent years, the number of web pages available on the global network known as the world wide web has increased dramatically. As a result of this increase in pages, various programs, called search engines, have become widely used to assist users in the process of searching for the content they want from the many pages that are available on the web. Search engines display listings of web sites in text form ranked in an order determined by each search engine. Meanwhile, as the number of web pages has increased, so too has the number of ways in which publishers of web pages can monetize their web sites, for example, by including advertisements or selling products.

Publishers of web content derive more visibility and potentially obtain more revenue the more people visit their sites. As a result, publishers strive to obtain the highest ranking possible in search engines. The higher the ranking, the more likely it is that the name and description of a site will be seen by users who will then visit a site. Publishers have implemented a variety of techniques to manipulate search engines to produce artificially high rankings. Users of search engines thus end up viewing results that are not necessarily relevant to their search, but that have been designed to appear artificially high in search engine rankings. This is known as search engine spam.

In addition to generating search engine spam, a number of publishers also generate web spam. Web spam consists of web pages that are created solely for the purpose of appearing in the search engines and then display content that is not inherently valuable but rather exists solely for the purpose of displaying ads or selling products. In its most extreme form, these pages consist of meaningless machine-generated content with advertisements and links. Users clearly do not obtain any benefit from the content, but they click on advertisements and affiliate links and buy products on these pages.

Much as users are plagued with electronic mail spam (unwanted electronic mail that is the Internet equivalent of junk mail) users are becoming plagued by search and web spam. The problem is that the average user of the world wide web is simply not aware of these nefarious endeavors, and is therefore led astray by the ever increasing problems of search and web spam. An even greater problem is that as more and more web and search spam is produced in the relentless drive for more revenue, the world wide web will devolve from a useful information resource to a useless spam-laden garbage dump.

### SUMMARY OF THE INVENTION

The present invention is a system and method for the detection and filtering of search and web spam. More specifically, the invention relates to a number of software modules, processes, and algorithms that perform these functions. By detecting and filtering out search and web spam, the invention provides a unique and novel way to view content that is relevant and meaningful to users of the world wide web.

In one aspect of the invention, a server-based detection and filtering system is implemented. In this design, the software for the detection and filtering of spam runs on a server computer system running the Linux operating system. When the user uses a client-based program called a web browser to connect to a web page on the server, and enters one or more keywords to search for, the software on the server retrieves a list of results that corresponds to the keyword or keywords entered by the user. It then runs one or more algorithms on these results to determine which results are spam and which are not. Then, depending on the preferences the user has configured, the non spam results are returned to the client browser program and displayed to the user, or both the spam and not spam results are returned to the client browser program but the spam results are indicated as such.

In another aspect of the invention, the server-based detection and filtering system runs on its own, that is, without the user specifying a particular set of keywords. The software crawls the world wide web given a list of one or more web sites to start from. That is, the software analyzed at all the pages on a particular site referenced in the list, and analyzes all the pages pointed to by links in the aforementioned pages. This process continues on a repeated basis. As the software analyzes each page, it categorized the specified page as spam or not spam; the software can also look at multiple pages on a site in conjunction with each other to make a determination of whether the individual pages, or the site as a whole is a spam site.

The server-based system also gives the user a mechanism to provide feedback to the server-based software about whether a particular result was correctly categorized as spam or not spam. In one implementation, the user can click on one or more buttons on the results page displayed in the client browser application, which buttons indicate “spam” or “not spam.” That is, by clicking on a “not spam” button, the server software can receive an indication from the user that a result that was categorized as spam, for example, was incorrectly categorized, and should actually be categorized as “not spam.” Upon receiving this indication, the server software adjusts its algorithm accordingly.

The server software uses a variety of algorithms to analyze web pages and evaluate whether they are spam or not spam. The software can also be extended to use other algorithms not originally implemented. Algorithms include a Bayesian chain rule evaluator with sparse binary polynomial matching, a regular expression handler, a Hidden Markov Model, and other mechanisms.

In another aspect of the invention, similar search and web spam detection and analysis capabilities are implemented as described above but via a client-based mechanism. In one instance, the client mechanism is a toolbar that is installed in a client-based browser application. In another instance, the client mechanism is a browser itself which has in it the ability to remove spam from view of the user or to indicate to the user which results are spam.

In another aspect of the invention, a combination of client and server mechanisms are used, with the client performing reduced processing and obtaining lists of spam sites and/or spam characteristics from a server.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a drawing of a server based web spam filtering system when called by a user.

FIG. 2 is a schematic of the client web browser connecting to the server running the web spam filter software.

FIG. 3 shows the server based system when run off a list of Universal Resource Locators (URLs).

FIG. 4 shows a client-based implementation of the detection and filtering mechanism.

FIG. 5 illustrates how the client transmits blacklist and whitelist information to a server and receives updated lists.

FIG. 6 shows how the server processes lists received from the client and makes new lists available.

FIG. 7 is a flowchart illustrating the algorithms used for the detection of search and web spam content.

### DETAILED DESCRIPTION

Embodiments of method and apparatus for web spam filtering are described herein. In the following description, numerous specific details are set forth (such as the C and C++ programming languages indicated as the language in which the software described is implemented) to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

Thus, embodiments of this invention may be used as or to support a software program executed upon some form of processing core (such as the CPU of a computer) or otherwise implemented or realized upon or within a machine-readable medium. A machine-readable medium includes any mechanism for storing or transmitting information in a form readable by a machine (e.g., a computer). For example, a machine-readable medium can include such as a read only memory (ROM); a random access memory (RAM); a magnetic disk storage media; an optical storage media; and a flash memory device, etc. In addition, a machine-readable medium can include propagated signals such as electrical, optical, acoustical or other form of propagated signals (e.g., carrier waves, infrared signals, digital signals, etc.).

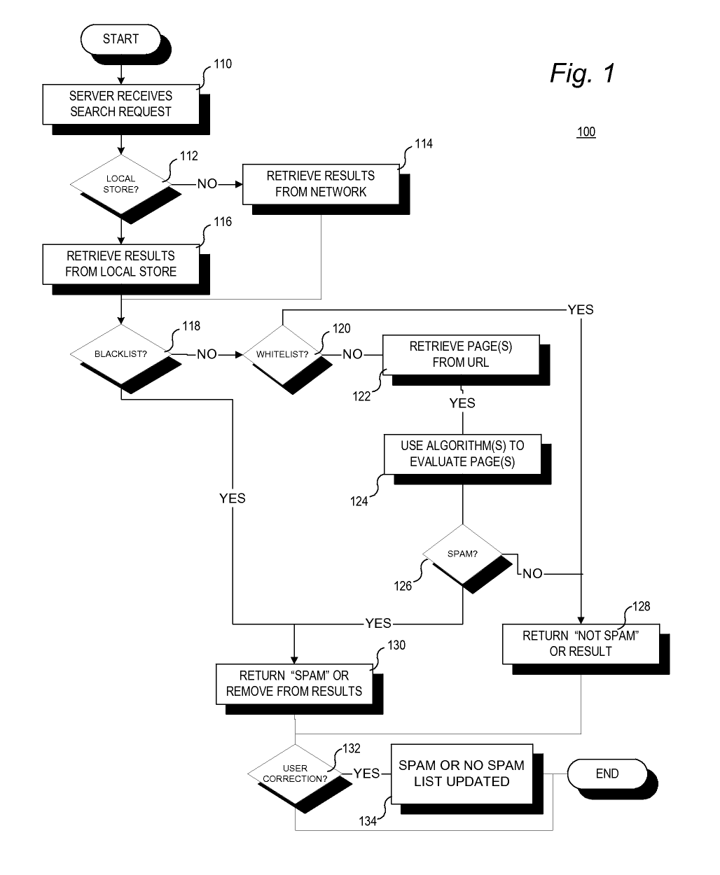

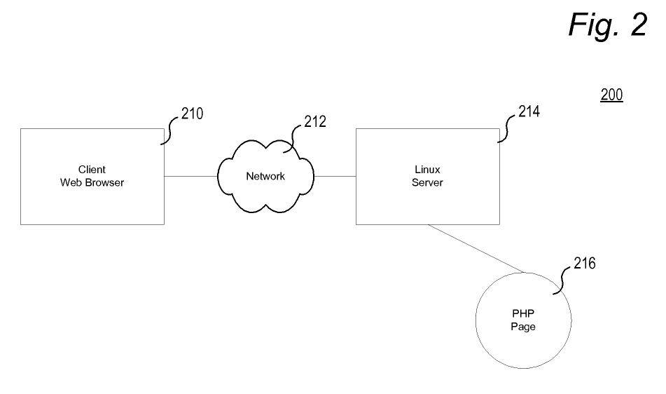

As shown in FIG. 1, drawing 100 illustrates the overall process for determining if a URL, the contents of the web page located at the address the URL points to, or related pages on the same or different web sites are spam. First, in step 110, the innovative software running on a Linux server receives a search request from client browser software 210 in FIG. 2 process 200 connecting to server 214 over network 212. The search request contains one or more keywords or phrases specified by the user on the client. In one implementation, the web spam filter page 216 is written using the PHP programming language running on a server running the Linux operating system and the Apache web server. Depending on the settings, the PHP page checks a configuration setting, step 112, to determine whether to retrieve results from its own database, or whether to query one or more search engines, such as Google, Yahoo, MSN, or other search engines available on the Internet.

If the configuration indicates that results are to be retrieved from a local database, the PHP uses the SQL query language to query a MySQL database to obtain URLs and associated descriptions that match the keyword or keywords passed as part of the search request, step 116. Alternatively, the PHP page contacts one or more search engines over a network connection, querying them for results that match the specified keyword or keywords, step 114. These search engines can be queried serially or in parallel.

For each URL in the returned list obtained from the search engines or from the database, the PHP page determines if the URL exists in a blacklist file, step 118, which indicates URLs that are already known to contain spam and do not need to be reprocessed. If the URL is in the blacklist, it is returned to the client with an indicator that it is spam, or optionally, it is removed altogether from the list of results returned to the client, step 130. If the URL is not in the blacklist, the PHP program determines if it is in the whitelist, step 120, which indicates that the specified URL is known not to contain spam and does not need to be processed. In this case, the result is returned to the client with an indicator that it is not spam, or alternatively, with no special indicator, step 128.

The software also supports a learning process, by which the user can indicate to the toolbar that a page or link identified as spam or not spam has been incorrectly identified. If the user clicks on the “spam” button that appears on the page next to a URL displayed on a page, this indicates to the server software, step 132, that the user is initiating a correction to the specified link. The server software then reprocesses the specified URL but identifies it as spam, step 134. Alternatively if the user clicks on a “not spam” button, the server software reprocesses the associated URL as containing valid, not spam content.

If the URL is in neither the blacklist nor the whitelist, the page pointed to by the URL is retrieved from the URL, step 122. In one implementation, the retrieved page is processed, and any URLs it contains are parsed and their contents retrieved (recursively, to a recursion level specified in a configuration file). In step 124, one or more algorithms are used to evaluate the retrieved page(s) to determine if they are spam or not. In step 126, a determination is made as to whether the retrieved content is spam; if it is, step 130 is executed and the blacklist is updated to include the specified URL. If it is not spam, step 128 is executed and the whitelist is updated to include the specified URL.

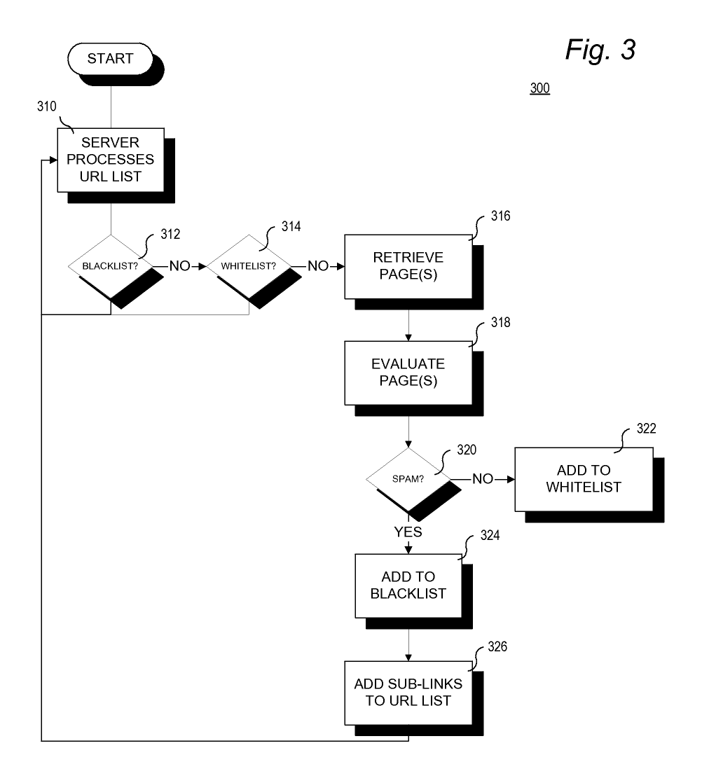

Due to the amount of processing power required to determine whether a page is spam or not, it is preferable in some instances to have the server evaluate URLs and their contents on an on-going basis, as illustrated in FIG. 3, rather than only when called by the user. As shown in process 300, the server runs on an on-going basis, first reading a list of URLs, step 310. For each URL in the list, the web spam filter server software determines if the URL exists in the blacklist, decision point 312. If it does, it moves to the next URL in the list. If the URL does not exist in the list, the server software determines if the URL is in the whitelist, decision point 314; if it is, it processes the next URL in the list. If the URL is not in the whitelist, the server software retrieves the page, step 316, at the URL location. In some instances, the server retrieves more than one page, for example if the specified page contains frames, which specify that the page is a container for multiple sub-pages. In step 318, the web filter software evaluates the retrieved page or pages, step 318, to determine if they are spam at decision point 320. If the page or pages are spam, they are added to the blacklist, step 324; if not they are added to the whitelist, step 322.

It should be noted that the web filter software can use multiple pages to evaluate whether a URL is spam or not; that is, in addition to the frames concept described earlier, depending on how it is configured, the software may download multiple pages from a particular web site, evaluating them conjointly, to determine if they are spam. While a particular page may not be identified as spam, sometimes multiple pages when evaluated together, or sub-links, when evaluated, are determined to be spam. In step 326, sub-links contained within an evaluated page are then added to the URL list for further processing.

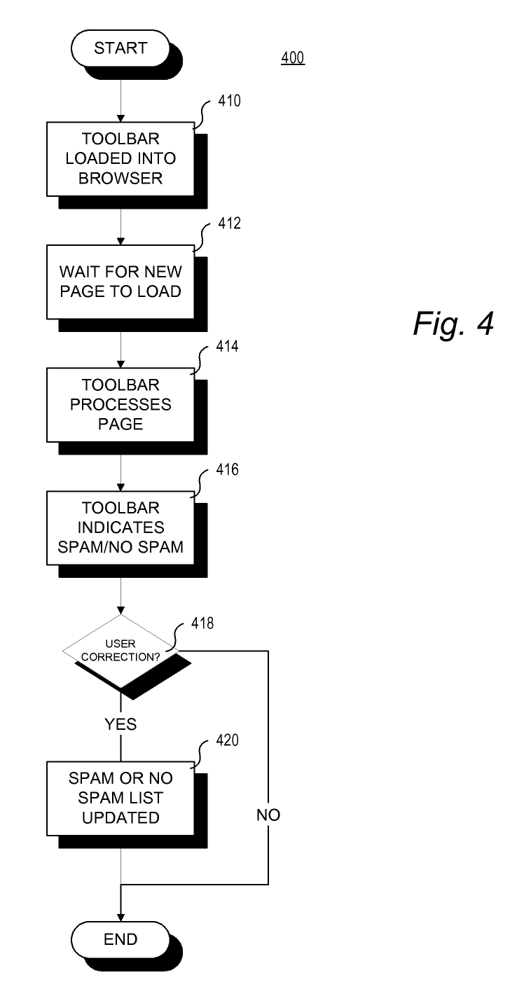

The illustrations described so far have focused primarily on the server-based aspects of filtering web spam. A client-based implementation is described in FIG. 4 process 400. In this implementation, a toolbar, which is a piece of software that runs inside a web browser application running on a client computer, is loaded into the browser, step 410. One implementation is a toolbar for the Internet Explorer browser, another is for the Firefox browser.

In step 412, the toolbar waits for a new page to be loaded into the browser by the user. When the toolbar detects that a new page has been loaded, it evaluates the page to determine whether the page itself, or the links contained within it, are search spam or web spam, step 414. The toolbar then indicates, using an image in the toolbar, whether the page itself is spam or not spam; it also modifies the page so that when the user places the mouse cursor over a URL link in the page, a popup will indicate whether the particular link points to a page that is spam or not spam, step 416. In this way, the toolbar indicates to the user whether content the user is currently viewing, or thinking about viewing, is spam.

The toolbar also supports a learning process, by which the user can indicate to the toolbar that a page or link identified as spam or not spam has been incorrectly identified. If the user clicks on the “spam” button that appears on the toolbar, this indicates to the toolbar, step 418, that the user is initiating a correction to the current page or to one of the links identified in the page currently visible in the browser. The toolbar then reprocesses the contents of the current URL but identifies it as spam, step 420. Alternatively if the user clicks on the “not spam” button in the toolbar, the toolbar reprocesses the current page identifying it as containing valid, not spam content.

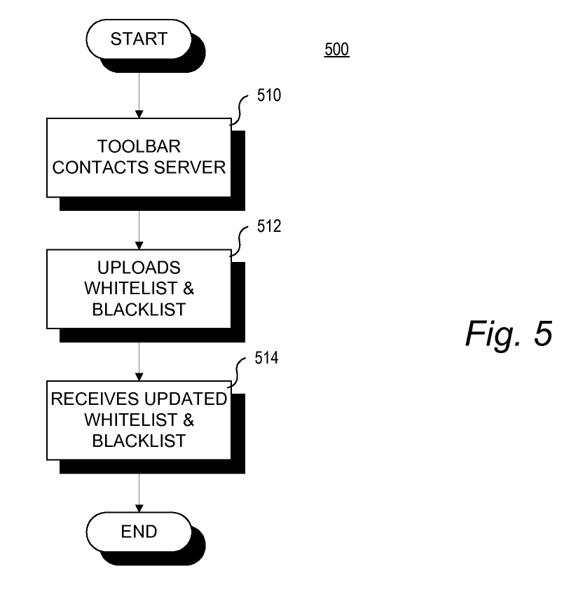

Toolbars installed on individual client computers can use a server to both backup their blacklist and whitelist information and to benefit from the network effects of multiple users determining which pages on the world wide web constitute spam, as shown in FIG. 5. In process 500, the toolbar first contacts the server, step 510, identifying itself to the server. Then, it uploads its whitelist and blacklist information to the server in compressed format, step 512, and receives a master whitelist and blacklist from the server, step 514. The master list is a combination of URLs for the specified client and URLs that have been indicated to be spam by all users who are members of the search and web spam filtering network.

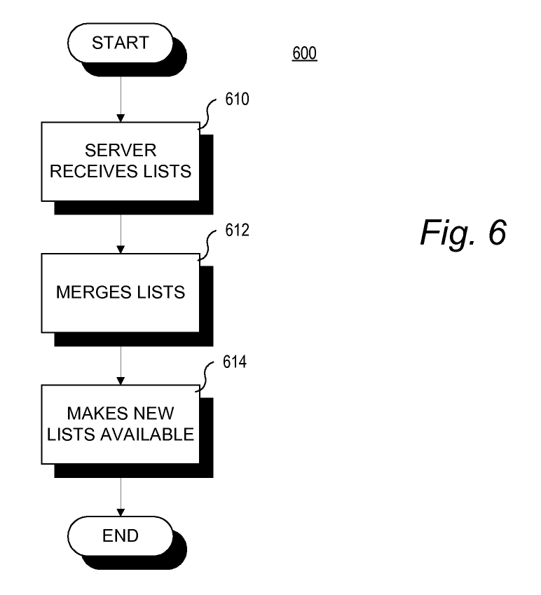

FIG. 6, process 600, illustrates the server-side aspects of the aforementioned network processing. In step 610, the server receives lists from one or more clients. Using various algorithms, the server merges the list to form a master list, step 612, while maintaining list information that may be specific to particular clients. The server software then makes the new lists available to clients to download, step 614.

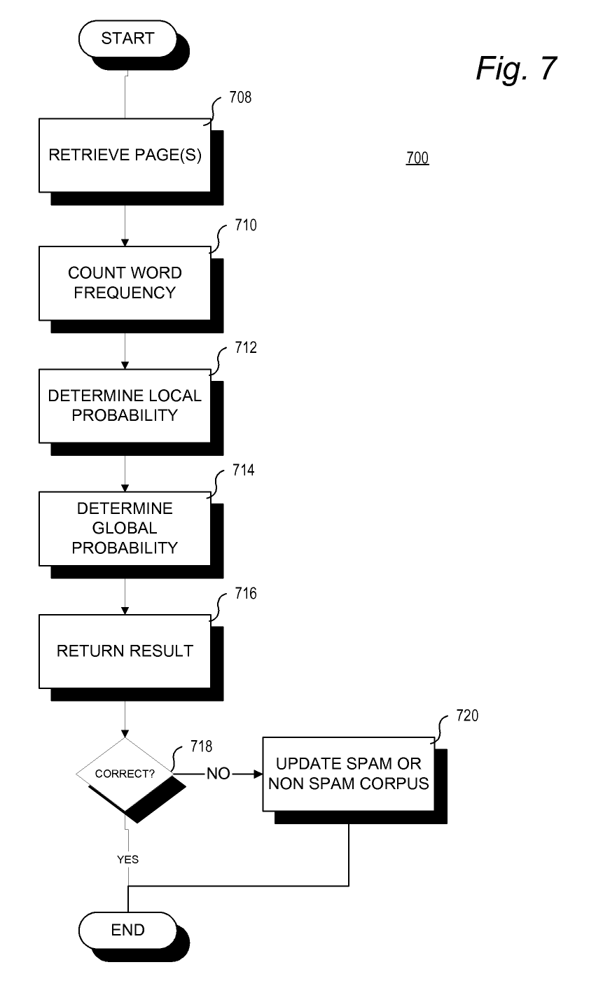

FIG. 7 illustrates the algorithmic process used for determining whether a particular URL's content is spam. A variety of algorithms are supported, including Bayesian matching and Markovian matching. In will be recognized by one skilled in the art that Bayesian and Markovian algorithms have been publicly available for many years; however, they have been uniquely implemented as part of the web page spam detection process in the current invention.

As shown in FIG. 7 process 700, the software (whether server or toolbar) first retrieves one or more pages given one or more URLs, step 708. The software then counts the word frequencies of the words contained in the retrieved content, step 710. This word frequency is then compared to the software's stored spam and non-spam corpi, that is, locally stored files containing content categorized as spam or not spam, to determine the local probability of a particular word being spam, step 712. All of the local probabilities are then combined to determine the global probability, step 714, of the retrieved content being spam or not spam. The probability of the content being spam or not spam, along with an indicator of whether the content is spam or not spam, based on whether the global probability exceeds the threshold for spam or not spam is then returned, step 716. Unlike the Bayesian algorithm, which assigns probabilities to individual words within the retrieved content, the Markovian implementation uses a sliding window of words to determine probabilities. Finally, the software accepts training by the user, as indicated earlier, step 718, through buttons on a web page or in the toolbar. If a correction is initiated, the spam or non-spam corpus, as appropriate, is updated, step 720.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

What is claimed is:

1. A system comprising: means for determining if a Universal Resource Locator is listed in a blacklist; means for determining if a Universal Resource Locator is listed in a whitelist; and means for determining, if a Universal Resource Locator is neither in a blacklist nor a whitelist whether the contents of the web page at the address specified by the Universal Resource Locator are spam.

2. A system as recited in claim 1, wherein the means for determining if the contents are spam uses a Bayesian matching algorithm.

3. A system as recited in claim 1, wherein the means for determining if the contents are spam uses a Markovian matching algorithm.

4. A system comprising: means for accepting user input via a toolbar running in a client web browser to indicate that a web page at the address specified by a Universal Resource Locator is spam; means for accepting user input via a toolbar to indicate that a web page is not spam; means for uploading a spam indicator to a server; means for uploading a not spam indicator to a server; and means for indicating to a user whether a web page the user may be about to browse to is a spam or not spam web page.

5. A system as recited in claim 4, wherein the means for indicating is a graphical popup window that is displayed by the toolbar if the user places the mouse cursor over a Universal Resource Locator link in a web page.

6. A system as recited in claim 4, wherein the means for accepting user input to indicate that the contents of a web page is spam is a graphical button displayed in a toolbar
